(19) United States
(12) Patent Application Publication
(10) Pub. No.: US 2020/0145646 A1
(43) Pub. Date: May 7, 2020

(54) SYSTEMS AND METHODS FOR DISPLAYING STEREOSCOPIC CONTENT

(71) Applicant: DOUBLE X VR LTD., Petach Tikva (IL)

(72) Inventor: Gal ROTEM, Petah Tikva (IL)

(21) Appl. No.: 16/615,794

(22) PCT Filed: May 23, 2018
(86) PCT No.: PCT/IL2018/050562

§ 371 Date: Nov. 21, 2019

(30) Foreign Application Priority Data
May 28, 2017 (GB) 1708526.7

(51) Int. Cl. H04N 13/344; H04N 13/366; H04N 13/128

(52) U.S. Cl. CPC H04N 13/344; H04N 13/128; H04N 13/366

(57) ABSTRACT

A head-mounted display includes a right-eye display area and a left-eye display area. A content rendering module retrieves, from a content source, content that includes two dimensional components of content. Each of the components has associated depth properties that have an associated offset value. The content rendering module generates content for the right-eye display area from the retrieved content by applying, for each component, a horizontal shift to the component in a respective first direction by the offset value associated with the component. The content rendering module generates content for the left-eye display area from the retrieved content by applying, for each component, a horizontal shift to the component in a respective second direction opposite the respective first direction by the offset value associated with the component rendering module. The content rendering module then sends the generated content to the respective right-eye and left-eye display areas.

### CROSS-REFERENCE TO RELATED APPLICATIONS

This application claims priority from UK Provisional Patent Application No. 1708526.7, filed May 28, 2017, whose disclosure is incorporated by reference in its entirety herein.

### TECHNICAL FIELD

The present invention relates to systems and methods for displaying digital content.

### BACKGROUND OF THE INVENTION

Head-mounted electronic displays devices, such as virtual reality (VR) headsets, or other electronic devices mountable on head-mounted display holders, provide users with comfortable hands-free viewing of stereoscopic video content (e.g., movies, video games, etc.). However, many other forms of content, such as, for example, web content, must be either specialized for VR systems, and therefore require hardcoded applications, making access to viewing such content difficult for users, or the content is not suitable for viewing on stereoscopic viewing devices, such as in the case of conventional websites.

### SUMMARY OF THE INVENTION

The present invention is directed to systems and methods for displaying stereoscopic content on a head-mounted display.

Embodiments of the present invention are directed to a system for displaying content. The system comprises: a head-mounted display including a display configured to be positioned in front of a user, the display having a first display area for displaying content for a right eye of the user and a second display area for displaying content for a left eye of the user; and a content rendering module configured to: retrieve, from a content source, content that includes one or more two-dimensional components of content, each of the one or more components having associated depth properties, the depth properties of each component having an associated offset value, generate content for the first display area from the retrieved content by applying, for each of the one or more components, a horizontal shift to the component in a respective first direction by the offset value associated with the component, generate content for the second display area from the retrieved content by applying, for each of the one or more components, a horizontal shift to the component in a respective second direction opposite the respective first direction by the offset value associated with the component, and send the generated content to the respective first and second display areas.

Optionally, the content is web content.

Optionally, the content source is a website.

Optionally, the depth properties of each of the one or more components are assigned by the content rendering module.

Optionally, the depth properties of each of the one or more components are assigned by the content source.

Optionally, the head-mounted display is configured to: receive the generated content for the first display area and the generated content for the second display area, display on the first display area the generated content for the first display area, and display on the second display area the generated content for the second display area.

Optionally, the first and second display areas are non-overlapping display areas.

Optionally, the system further comprises: a sensor subsystem functionally associated with the head-mounted display, the sensor subsystem configured to: detect movement of the head of the user, and based on the detected movement, provide positional data associated with the head of the user to the content rendering module.

Optionally, the content rendering module is further configured to: receive the positional data from the sensor subsystem, and for each of the one or more components, apply a horizontal shift by a second offset value in the first direction or the second direction, wherein the direction of the horizontal shift by the second offset value is a function of the received positional data.

Optionally, the second offset value is a function of the depth properties of the component.

Optionally, the received positional data is indicative of rotational or translational movement of the head of the user in the first or second directions.

Optionally, the horizontal shift by the second offset value is in a direction opposite the direction of rotational or translational movement of the head of the user.

Optionally, the sensor subsystem includes at least one sensor in the form of an accelerometer.

Optionally, the sensor subsystem is carried by the head-mounted display.

Embodiments of the present invention are directed to a method for displaying content. The method comprises: positioning a display of a head-mounted display in front of a user, the display having a first display area for displaying content for a right eye of the user and a second display area for displaying content for a left eye of the user; retrieving, from a content source, content that includes one or more two-dimensional components of content, each of the one or more components having associated depth properties, the depth properties of each component having an associated offset value; applying, for each of the one or more components, a horizontal shift to the component in a respective first direction by the offset value associated with the component to generate content for the first display area from the retrieved content; applying, for each of the one or more components, a horizontal shift to the component in a respective second direction opposite the respective first direction by the offset value associated with the component to generate content for the second display area from the retrieved content; and sending the generated content to the respective first and second display areas.

Optionally, the method further comprises: receiving the generated content for the first display area and the generated content for the second display area; displaying on the first display area the generated content for the first display area; and displaying on the second display area the generated content for the second display area.

Optionally, the method further comprises: detecting movement of the head of the user; receiving positional data associated with the head of the user, the positional data being derived from the detected head movement; and for each of the one or more components, applying a horizontal shift by a second offset value in the first or second direction according to the received positional data.

Embodiments of the present invention are directed to a system for displaying content. The system comprises: a head-mounted display configured to be positioned in front of a user, the head-mounted display including a display having a first display area and a second display area; a sensor subsystem functionally associated with the head-mounted display configured to: detect movement of the head of the user, and derive positional data associated with the head of the user from the detected movement; and a content rendering module configured to: retrieve, from a content source, content that includes one or more two-dimensional components of content, each of the one or more components having associated depth properties, receive the positional data from the sensor subsystem, calculate, for each of the one or more components, an associated offset value based on the depth properties of the component and the derived positional data, generate content for the first display area from the retrieved content by applying, for each of the one or more components, a horizontal shift to the component in a respective first direction by the offset value associated with the component, generate content for the second display area from the retrieved content by applying, for each of the one or more components, a horizontal shift to the component in a respective second direction opposite the respective first direction by the offset value associated with the component.

Embodiments of the present invention are directed to a method for displaying content. The method comprises: displaying, on a first display area of a head-mounted display positioned in front of a user, a first version of one or more two-dimensional components of content derived from source content; displaying, on a second display area of the head-mounted display, a second version of the one or more two-dimensional components of content derived from source content, wherein for each of the one or more components, the component of the first version is horizontally shifted in a first direction by an offset amount associated with a depth property of the component, and a corresponding component of the second version is horizontally shifted in a second direction opposing the first direction by the offset amount; receiving positional data indicative of movement of the head of the user; calculating, for each of the one or more components, a second offset value based on the depth properties associated with the components and the received positional data; and applying, for each of the one or more components of the first and second versions, a horizontal shift to the component in the first direction or the second direction by the second offset value associated with the component.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a schematic representation of an example environment in which embodiments of the invention can be performed by a user wearing a head-mounted display;

FIG. 2 is a front view of a display of the head-mounted display, from the perspective of the user, according to an embodiment of the invention;

FIG. 3 is a top view of the display, corresponding to FIG. 2, according to an embodiment of the invention;

FIG. 4 is a block diagram of a system for displaying stereoscopic content on the head-mounted display, according to an embodiment of the invention;

FIG. 5 is a diagram of an illustrative example environment in which embodiments of the invention can be performed;

FIG. 6 is a schematic representation of components of content of a content source, according to an embodiment of the invention;

FIGS. 7A and 7B are schematic representations of a left-eye version and a right-eye version, respectively, of the components of content of FIG. 6 after undergoing left-right shifts by a pixel offset value for each component, according to an embodiment of the invention;

FIG. 8A is a schematic representation of the left-eye version of FIG. 7A after undergoing shifts, for each component, by a calculated pixel offset value in response to detected movement of the head-mounted display to the left, according to an embodiment of the invention;

FIG. 8B is a schematic representation of the right-eye version of FIG. 7B after undergoing shifts, for each component, by a calculated pixel offset value in response to detected movement of the head-mounted display to the left, according to an embodiment of the invention;

FIG. 8C is a schematic representation of the left-eye version of FIG. 7A after undergoing shifts, for each component, by a calculated pixel offset value in response to detected movement of the head-mounted display to the right, according to an embodiment of the invention;

FIG. 8D is a schematic representation of the right-eye version of FIG. 7B after undergoing shifts, for each component, by a calculated pixel offset value in response to detected movement of the head-mounted display to the right, according to an embodiment of the invention;

FIG. 9 is a diagram of the architecture of an exemplary processing system through which embodiments of the present invention can be performed;

FIG. 10 is a flow diagram illustrating a process for displaying stereoscopic content retrieved from a content source on the head-mounted display of FIG. 1.

### DESCRIPTION OF THE PREFERRED EMBODIMENTS

The present invention is directed to systems and methods for displaying stereoscopic content on a head-mounted display.

The present invention is applicable to different types of presentations of digital content on head-mounted displays. Such presentations include, but are not limited to, web content from websites, content displayed from a video game console, digital media presentations, and VR content viewed as part of a VR system.

The principles and operation of the systems and methods according to present invention may be better understood with reference to the drawings accompanying the description.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways. Initially, throughout this document, references are made to directions such as, for example, left and right, and the like. These directional references are exemplary only to illustrate the invention and embodiments thereof.

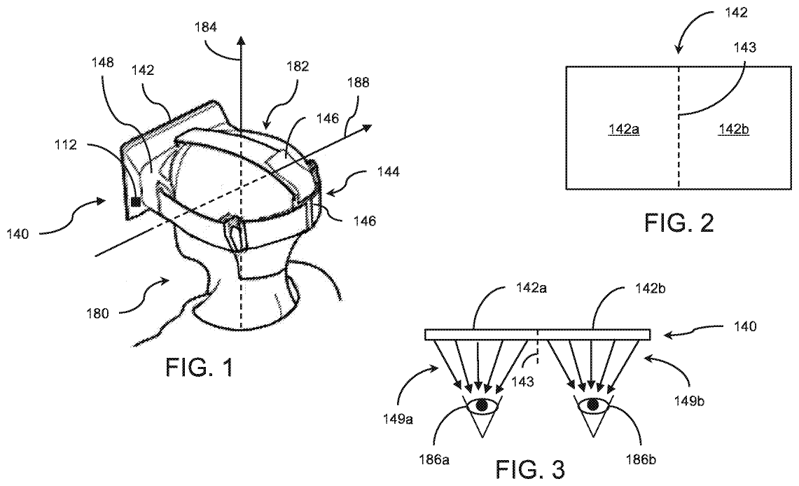

Referring now to the drawings, FIG. 1 shows a schematic representation of an example environment in which embodiments of the present disclosure can be performed when used by a user 180. A head-mounted display (referred to hereinafter as an HMD) 140 is configured to be worn on the head 182 of the user 180 and may be affixed to the head 182 via a head attachment mechanism 144 which may be implemented as one or more adjustable straps 146 which engage the back and top portions of the head 182. The HMD 140 includes a display 142 for displaying content to the user 180. The display 142 is positioned in front of the user when the HMD 140 is worn on the head 182. The HMD 140 includes electronic components, which may be embedded within a housing of the display 142, for receiving electronic data and signals, and image processing circuitry for processing and displaying such data and signals in the form of the pixels on the display 142.

In the non-limiting implementation illustrated in FIG. 1, the HMD 140 is implemented as a single unit headset, for example a virtual reality (VR) headset, in which the electronic components for receiving electronic data and signals, the image processing circuitry, and the display 142 are integrated as a single unit. In such an implementation, the display 142 and the associated electronic components are attached to a display mounting mechanism 148, that is attached to the head attachment mechanism 144, which helps to properly position and align the display 142 in front of the eyes of the user 180 when the when the HMD 140 is worn by the user 180.

In an alternative non-limiting implementation, the HMD 140 may be implemented as a combination of a separate mobile communication device, which can be readily transported from one location to another, and that is detachably mounted to the display mounting mechanism 148. Such mobile communication devices include, but are not limited to, tablet computing devices (e.g., iPad from Apple of Cupertino, Calif.), smartphones (e.g., iPhone from Apple of Cupertino, Calif.), and VR headsets (e.g., Oculus Rift from Facebook of Menlo Park, Calif.). In such an implementation, the mobile communications device includes all electronic components and circuitry for receiving electronic data and signals and performing image processing on the received data and signals.

One or more sensors 112, depicted as a single sensor in FIG. 1 for clarity, are functionally associated with the HMD 140. The sensors 112 function to detect movement of the head 182 of the user 180. The functional association with the HMD 140 may be accomplished in various ways, for example, by attaching the sensors 112 to a portion of the head-mounted display holder 144, or by attaching the sensors 112 to an external portion of the HMD 140 near the housing of the display 142, as exemplarily illustrated in FIG. 1.

With continued reference to FIG. 1, refer now to FIGS. 2 and 3, a front view and a top view of the display 142, respectively. FIG. 2 illustrates a front view of display 142, as seen from the perspective of the user 180 when the HMD 140 is worn by the user 180. The display 142 is partitioned into two separate non-overlapping display areas, namely a left-eye display area 142a (referred to hereinafter as the left display area 142a) and a right-eye display area 142b (referred to hereinafter as the right display area 142b). The display 142 is partitioned such that the left display area 142a is positioned in front of the left eye 186a of the user 180 and the right display area 142b is positioned in front of the right eye 186b of the user 180 when the HMD 140 is worn on the head 182. The left display area 142a functions to project images (represented by the collection of light rays 149a) displayed on the left display area 142a into the left eye 186a, and the right display area 142b functions to project images (represented by the collection of light rays 149b) displayed on the right display area 142b into the left eye 186b. The light rays 149a and 149b represent only a small sample of the many rays of light emitted by the various pixels elements of the display 142.

The partitioning of the display 142 may be effectuated as a physical partition 143, which may be implemented as a barrier constructed in the HMD 140 that sits on or near the bridge of the nose when the HMD 140 is worn by the user 180. The partition 143 effectively blocks the images displayed by the right display area 142b from being projected into the left eye 186a, and blocks the images displayed by the left display area 142a from being projected into the right eye 186b. As such, the left eye 186a only views images from the left display area 142a, and the right eye 186b only views images from the right display area 142b. As will be discussed in further detail below, the components of the images from the display areas 142a and 142b which are projected into the eyes 186a and 186b are horizontally offset from each other by specific pixel amounts, such that the final image perceived by the user 180 is a stereoscopic image.

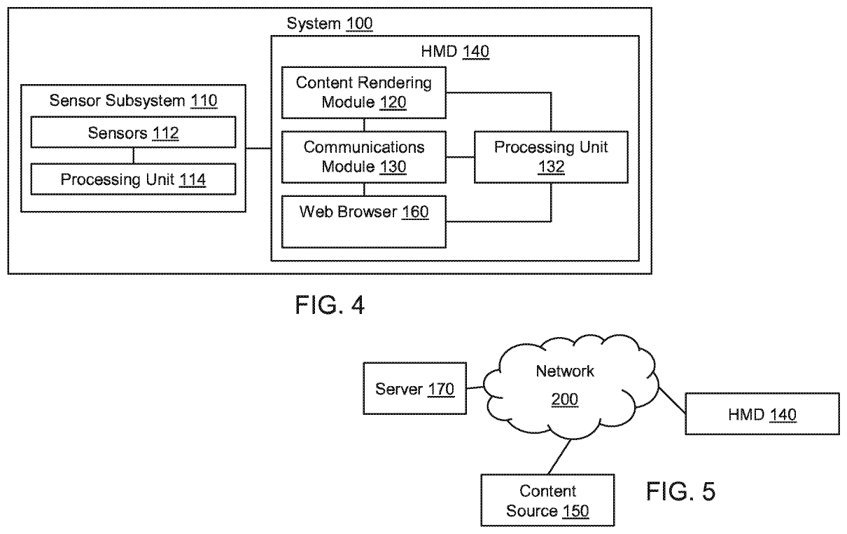

With continued reference to FIGS. 1-3, refer now to FIG. 4, which illustrates a block diagram of a system, generally designated 100, for displaying stereoscopic content, according to an embodiment of the present disclosure. The system 100 includes the HMD 140 and a sensor subsystem 110. The sensor subsystem 110 includes the one or more sensors 112 and a processing unit 114 for processing data derived from head movement detected by the sensors 112 and for providing the processed data to other components of the system 100.

It is generally noted that many current mobile communication devices include various sensors and processors as part of the device. For example, tablet computing device and smartphones typically include accelerometers for detecting various positional and temporal related attributes of the device. In implementations in which the HMD 140 is implemented as a combination of a separate mobile communication detachably mounted to the display mounting mechanism 148, the sensors 112 are implemented as one or more sensors of the mobile communication device, thereby allowing the system 100 to leverage such sensors and/or processors of the mobile communication device.

The head movement detected and processed by the sensor subsystem 110 is in response to movement of the head 182 about one or more axes of rotation, which is typified by rotational movement about, for example, the yaw axis 184 (i.e., movement of the head 182 to the right and to the left) and/or the pitch axis 188 (i.e., movement of the head 182 up and down). The sensor subsystem 110 is configured to detect and process head movement in real-time (or in near real-time), thereby enabling continuous tracking of head movement between positions, for example, between an initial position and a final position.

The sensors 112 provide data-bearing electrical signals to the processing unit 114 to enable the tracking of head movement by evaluating a change in the position of the head 182 over time. The head position includes the position in free space which may change due to translational movement between points in free space (e.g., caused by walking forward while turning the head to the left). The head position may also include angular position (i.e., pointing direction) which may change due to rotation of the head about the yaw axis 184 (i.e., movement of the head 182 to the left and right). The data received by the processing unit 114 may include information indicative of both free space position and angular position of the head 182 relative to a zero-angle corresponding to the head 182 looking straight ahead.

The sensors 112 may be implemented in various ways. For example, in certain non-limiting implementations, the sensors 112 are implemented as one or more accelerometers. In other non-limiting implementations, the sensors 112 are implemented as one or more velocity sensors. In yet other non-limiting implementations, the sensors 112 are implemented as one or more position sensors (e.g., potentiometers, etc.). In embodiments in which the sensors 112 are implemented as accelerometers, the accelerometric data captured by the accelerometer may be converted into position via, for example, double integration of the acceleration with respect to time, and calculating the change in position over time, caused by the change from the initial position of the head 182 to the final position of the head.

With continued reference to FIG. 4, the system 100 further includes a content rendering module 120, a communications module 130, and a processing unit 132, which are shown as components of the HMD 140 in FIG. 1. The components of the system 100 operate jointly to provide content (e.g., web content) for stereoscopic display as images by the HMD 140.

The processing unit 132 is configured to provide processing and control functionality to the HMD 140. Such functionality may include, but is not limited to, actuation of the communications module 130, processing of the data received by the communications module 130, processing of content rendered by the content rendering module 120, and execution of the functionalities of the content rendering module 120. The processing units 114 and 132 may be implemented as a single processing system with one or more processors to provide capability for executing the functionalities of the all of the major components of the system 100 (e.g., the sensor subsystem 110, content rendering module 120, communications module 130, etc.).

FIG. 5 shows an illustrative example environment in which embodiments of the present disclosure can be performed over a network 200. The network 200 may be formed of one or more networks, including, for example, the Internet, cellular networks, wide area, public, and local networks. The HMD 140 receives content from a content source 150 for display to the user 180 via the display 142. The content source 150 provides content in the form of two-dimensional content components, and may be, for example, a website which provides web content, hosted by a server 170, to the HMD 140. The web content can include image content, video content, streaming content, graphical content, text, or any other content typically accessed through websites. In embodiments in which the content source 150 provides web content, the system 100 further includes a web browser 160, which may be included in the HMD 140. The web browser 160 is, for example, any web browser used on a computer system for accessing data on the world wide web, such as, for example, Microsoft® Internet Explorer®, Mozilla Firefox®, or Google Chrome®. The communications module 130 preferably includes a network interface to the network 200 for allowing web access and the exchange of data between the network 200 (and computers connected to the network 200) and the HMD 140. In embodiments in which the HMD 140 includes the web browser 160, execution of the functionalities of the web browser 160 is provided by the processing unit 132.

Note that although the block diagram of the system 100 that is shown in FIG. 4 depicts the content rendering module 120 as being part of the HMD 140 (i.e., embedded inside the HMD 140 as a component), the content rendering module 120 may be external to, and separate from, the HMD 140. For example, in certain embodiments, the content rendering module 120 may be linked to the server 170 and the HMD 140 via the network 200. In such embodiments, the HMD 140, via the processing unit 132, sends commands to the rendering module 120 to perform the functionality associated with rendering module 120 in response to user content requests (e.g., web browsing activity).

Also note that one or more components of the sensor subsystem 110 may be included as components of the HMD 140, for example, as discussed above in implementations in which a mobile communication device is used in combination with the display mounting mechanism 148 to form the HMD 140.

The communications module 130 preferably further includes components, including, but not limited to, processors, filters, signal amplifiers, demodulators, and analog-to-digital conversion blocks, for receiving and processing information (i.e., data and signals) from the network 200, and providing such received and processed information to the processing unit 132 and the content rendering module 120 for further processing.

The content rendering module 120 functions to retrieve content from the content source 150 and reconstruct the content from the content source 150 twice, to generate a left-eye version and a right-eye version of the content, which when viewed by the user 180 on the display 142 promote a stereoscopic effect, thereby transforming the two-dimensional content from the content source 150 into three-dimensional stereoscopic content. More specifically, the content rendering module 120 reconstructs the content from the content source 150 as a first reconstruction for display by the left display area 142a and reconstructs the content from the content source 150 as a separate second reconstruction for display by the right display area 142b. In a non-limiting example in which the content source 150 is a website, the content rendering module 150 retrieves the web content from the website, in response to browsing activity via the web browser 160, and reconstructs a left eye version of the website for display by the left display area 142a and reconstructs a right eye version of the website for display by the right display area 142b.

In order to reconstruct the content from the content source 150, the content rendering module 120 first retrieves the content from the content source 150. The retrieval may be performed via the communications module 130, which may be commanded, by the content rendering module 120, to retrieve the components which make up the content. The components (also referred to “components of content” or “content components”) may include a variety of different component types, including, but not limited to, image or picture components, video components, text components, and shape components. Such components may include internal content, such as text paragraphs components, whose internal content includes displayed text, as well as font, formatting and layout information. The components may be static, in which such a component does not move from a given position, or dynamic, in which the position of such a component may change, either periodically, intermittently, or continuously.

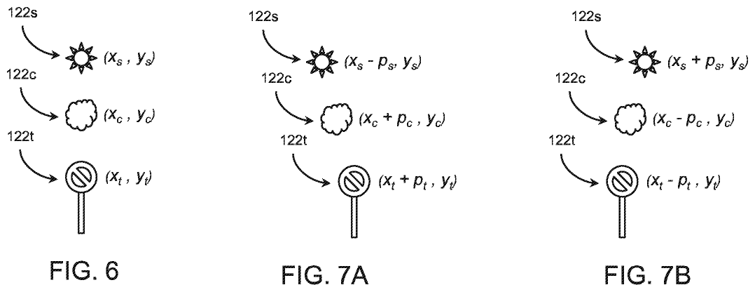

An example of a content source (e.g., a website) comprised of three components is illustrated in FIG. 6. For illustration purposes, the first component is represented schematically as a sun 122s, the second component is represented schematically as a cloud 122c, and the third component is represented schematically as a traffic sign 122t. The components 122s, 122c, 122t are two-dimensional components, and are arranged for display in the content source according to the design specifications of the content creator (e.g., web designer). Each component has one or more depth properties associated therewith which provide an indication of the stereoscopic depth of that component. According to certain embodiments, the depth properties of each component are assigned by the content rendering module 120 upon retrieval of the components from the content source 150. The content rendering module 120 may assign the depth properties according to the component type and may include default depth values according to the component type. For example, image components may be assigned as a common set of depth properties having a certain depth value (i.e., default depth value), while text components may be assigned a different common set of depth properties having a different depth value. In instances when the content source 150 is a website, for example, the depth properties of components may be assigned according to HTML properties (e.g., tag name, component position, etc.). Accordingly, the content rendering module 120 enables the display of a two-dimensional content source that lacks any embedded depth properties as a three-dimensional stereoscopic display when displayed on the display 142. In other embodiments, the depth properties of each component are assigned dynamically or statically by the content creator such that the content source 150 itself includes depth properties for each component. Accordingly, each component of content has a depth associated therewith, thereby enabling the content rendering module 120 to generate the left-eye and right-eye displays according to the associated component depths. In embodiments in which the depth properties are assigned by the content creator, the depth properties of each component are preferably included in data file information associated with the content, such that when the content from the content source is retrieved by the content rendering module 120, the depth properties associated with each component of content are also retrieved by the content rendering module 120.

The depth properties provide an indication of the stereoscopic depth of each component of content. For example, the components 122s, 122c, 122t may have depth properties which indicate that the sun 122s be positioned in the background (i.e., behind the cloud 122c and the traffic sign 122t), the traffic sign 122t be positioned in the foreground, and the cloud 122c be positioned at the plane of the display 142 (i.e., zero depth). In order to achieve this effect, the depth properties of each component have a pixel offset value associated therewith, and the horizontal position of each component is shifted to the left and to the right by the associated pixel offset value.

In the non-limiting example illustrated in FIG. 6, each of the three components 122s, 122c, 122t has the same initial horizontal value on the x-axis, namely xₛ=x_{c}=xₜ, with different vertical values on the y-axis (yₛ, y_{c}, yₜ, respectively). In order to the achieve the stereoscopic depth effect in which the sun 122s is positioned in the background, the traffic sign 122t is positioned in the foreground, and the cloud 122c is positioned at near zero depth, each of the components are separately left and right shifted by the content rendering module 120 as follows:

1) The sun 122s is shifted to the left by a pixel offset amount pₛ and separately shifted to the right by the pixel offset amount pₛ, resulting in a left-shifted version of the sun 122s positioned at (xₛ−pₛ, yₛ) and a right-shifted version of the sun 122s positioned at (xₛ+pₛ, yₛ),

2) The traffic sign 122t is shifted to the left by a pixel offset amount pₜ and separately shifted to the right by the pixel offset amount pₜ, resulting in a left-shifted version of the traffic sign 122t positioned at (xₜ−pₜ, yₜ) and a right-shifted version of the traffic sign 122t positioned at (xₜ+pₜ, yₜ), and

3) The cloud 122c is shifted to the left by a pixel offset amount p_{c} and separately shifted to the right by the pixel offset amount pₛ, resulting in a left-shifted version of the cloud 122c positioned at (x_{c}−p_{c}, y_{c}) and a right-shifted version of the cloud 122c positioned at (x_{c}+p_{c}, y_{c}).

Note that ideally, the offset amount for components at or near zero depth (e.g., the cloud 122c) is small (e.g., approximately zero offset), and that the offset amount for components in the background (e.g., the sun 122s) is larger than the offset amount for components in the foreground (e.g., the traffic sign 122t). Accordingly, the offset amount increases, as components move from the foreground to the background.

FIGS. 7A and 7B illustrate the shifted versions of the components to be viewed by the left eye 186a and the right eye 186b, respectively, within the context of the above example described with reference to FIG. 6. The left eye display (FIG. 7A) displays the left shifted version of the sun 122s, the right shifted version of the traffic sign 122t, and the right shifted version of the cloud 122c. The right eye display (FIG. 7B) displays the right shifted version of the sun 122s, the left shifted version of the traffic sign 122t, and the left shifted version of the cloud 122c.

Note that the offset amounts of the left and right shifted versions of the components may be provided relative to each other. For example, the offset amount of a component to be positioned in the foreground may be provided as a function of the offset amount of a component to be positioned in the background, and vice versa. Further still, all offset amounts may be provided relative to a zero-depth offset value (i.e., no shift).

In operation, the content rendering module 120 retrieves (via the communications module 130) the content from the content source. The content rendering module 120 then checks data file information associated with the content to determine whether the components of content have assigned depth properties. If no depth properties are assigned, the content rendering module 120 assigns depth properties to each component. The content rendering module 120 then applies the independent left and right shifts, by the corresponding pixel offsets, to each of the components to generate separate left-eye and right-eye versions of the content. The content rendering module 120 then sends the left-eye version (e.g., FIG. 7A) to the left display area 142a, and the right-eye version (e.g., FIG. 7B) to the right display area 142b. As discussed above, the left eye 186a only views the content displayed by the left display area 142a and the right eye 186b only views the content displayed by right display area 142b, such that the resulting content viewed by the user 180 has stereoscopic depth.

Embodiments of the system 100 described thus far have pertained to presenting content to a user 180 wearing an HMD 140 in a manner in which the presented content is displayed to the user 180 as a stereoscopic presentation. In situations in which movement of the components of content in response to head movement by the user 180 is desired, such as, for example, in VR systems, embodiments of the system 100 provide such functionality.

As discussed above, the sensor subsystem 110 provides functionality for tracking of head movement of the user 180 by evaluating (via the processing unit 114 in response to signals received from the sensors 112) the real-time or near real-time change in position of the head 182. The positional information is provided to the content rendering module 120, which calculates a pixel offset value for each of the components of content. The content rendering module 120 applies the calculated pixel offset to each component in a single direction only, resulting in either a right-shift or a left-shift. The direction of the shift is a function of the direction of the detected head movement. Specifically, rotational movement about the yaw axis 184 corresponding to pointing the head 182 to the left results in a right-shift of the components, and rotational movement about the yaw axis 184 corresponding to pointing the head 182 to the right results in a left-shift of the components.

It is critical to emphasize that the components of the generated the right-eye and left-eye versions are shifted in the same direction. The amount of the shift for each component, dictated by the calculated pixel offset value, is a function of the perceived depth of the component, and in certain non-limiting implementations is inversely proportional to the perceived depth of the component. In other words, components that have a perceived depth placing them in the background have a relatively small calculated pixel offset value, whereas components that have a perceived depth placing them in the foreground have a relatively large calculated pixel offset value. The difference in magnitude of the calculated pixel offset value according to perceived depth contributes to a parallax effect for the user 180, as the components in the foreground appear to move faster (as the result of the larger pixel offset value) than the components in the background (which as the result of the smaller pixel offset value).

The amount of the shift for each component, dictated by the calculated pixel offset value, is also a function of the head position (in free space and/or angular position) provided to the content rendering module 120 by the sensor subsystem 110 in response to detected movement of the head 182. For example, larger changes in position (i.e., head movement farther to the left or right) translates to overall larger calculated pixel offsets in comparison to smaller changes in position (i.e., small head movement to the left or right).

The calculation of the pixel offset value for each component of different depth may be based on a mapping function that provides pixel offset as output in response to depth and head position provided as input. Alternatively, the calculation of the pixel offset value for each component of different depth may be based on a look-up table, stored in a memory or database linked to the content rendering module 120. Note that although both the offset value for present the content as a stereoscopic presentation, and the offset value for contributing to the parallax effect, have been described thus far as being pixel offset values, the offset values may be in the form of percentage shifts relative to the number of pixels in the resolution of the display 142.

Since the sensor subsystem 110 is effectively able to track the movement of the head 182 in real-time or near real-time, the updated position of the head is provided to the content rendering module 120 in real-time or near real-time. As such, the content rendering module 120 calculates the pixel offset value for each component at a relatively high refresh rate. The high refresh rate allows the HMD 140 to display the stereoscopic content to the user 180 such that the movement of the components in the left-eye and right-eye versions seen by the user 180, in response to user head movement, is virtually seamless.

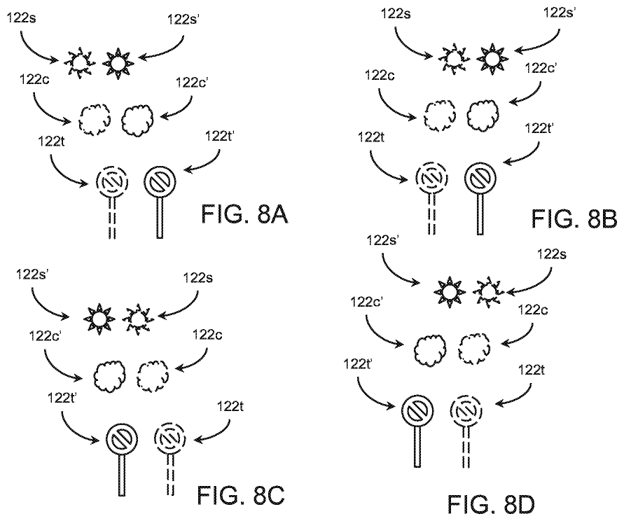

FIGS. 8A and 8B illustrate the instantaneous shifted versions of the left-eye and right-eye displays of FIGS. 7A and 7B, respectively, in response to head movement to the left. FIGS. 8C and 8D illustrate the instantaneous shifted versions of the left-eye and right-eye displays of FIGS. 7A and 7B, respectively, in response to head movement to the right. The components in FIGS. 8A-8D, in their original positions corresponding to what is shown FIGS. 7A and 7B, are depicted wish dashed lines and are labeled as 122s, 122c, 122t. In other words, the components prior to being shifted in response to head movement are shown in FIGS. 8A-8D with dashed lines. The components in FIGS. 8A-8D that are shifted in response to the head movement are labeled as 122s′, 122c′, 122t′.

In FIGS. 8A and 8B, the head 182 moves to the left (i.e., either translationally or rotationally), resulting in a right-shift of the components relative to the positioning illustrated in FIGS. 7A and 7B, respectively. As illustrated in FIGS. 8A and 8B, the components in the foreground (i.e., the traffic sign 122t′) are shifted more than the components in the background (i.e., the sun 122s′).

In FIGS. 8C and 8D, the head 182 moves to the right (i.e., either translationally or rotationally), resulting in a left-shift of the components relative to the positioning illustrated in FIGS. 7A and 7B, respectively. As illustrated in FIGS. 8C and 8D, the components in the foreground (i.e., the traffic sign 122t′) are shifted more than the components in the background (i.e., the sun 122s′).

It is noted that in response to the detected head movement by the sensor subsystem 110, the content rendering module 120 applies a left shift or a right shift (depending on the direction of detected movement), by the corresponding calculated pixel offsets, to each of the components to regenerate the separate left-eye and right-eye versions of the content derived from the content source. It is also noted that although the description of the content module 120 thus far has pertained to performing two shift instances, one to generate the left-eye and the right-eye versions of content for stereoscopic display, and another shift by a calculated pixel offset value to achieve the parallax effect, the content module 120 may also be configured to perform a single shift instance for each eye. More clearly, the pixel offset value associated with the depth properties of the components used to generate the left-eye and the right-eye versions of content for stereoscopic display may be combined with the calculated pixel offset value to form a single total pixel offset value for each component.

As should be apparent to one of ordinary skill in the art, the methods and systems according to the embodiments of the present disclosure are computerized methods and systems that require execution by computerized components and processors, such as those included computer processing systems (e.g., the processing units 114 and 132). The following paragraphs describe example architectures of such computer processing systems. The example architecture applies equally to both of the processing units 114 and 132 in implementations in which the processing units 114 and 132 are implemented as separate processing units.

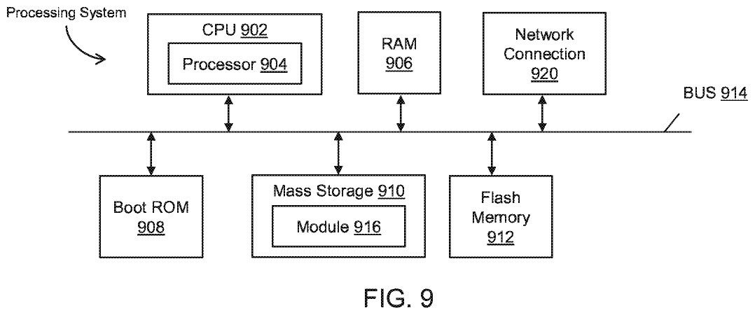

Referring now to FIG. 9, a diagram of an example architecture of a processing system exemplifying both of the processing units 114 and 132. The processing system includes a central processing unit (CPU) 902 that is formed of one or more processors 904 for performing various functions, including some or all of the processes and sub-processes shown and described in the flow diagrams of FIGS. 5 and 6. The processors, which can include microprocessors are, for example, conventional processors, such as those used in servers, computers, and other computerized devices. For example, the processors may include x86 Processors from AMD and Xeon® and Pentium® processors from Intel, as well as any combinations thereof.

The processing system further includes four exemplary memory devices: a random-access memory (RAM) 906, a boot read-only memory (ROM) 908, a mass storage device (i.e., a hard disk) 910, and a flash memory 912. As is known in the art, processing and memory can include any computer readable medium storing software and/or firmware and/or any hardware element(s) including but not limited to field programmable logic array (FPLA) element(s), hard-wired logic element(s), field programmable gate array (FPGA) element(s), and application-specific integrated circuit (ASIC) element(s). Any instruction set architecture may be used in the CPU 902 including but not limited to reduced instruction set computer (RISC) architecture and/or complex instruction set computer (CISC) architecture. A module (i.e., a processing module) 916 is shown on the mass storage device 910, but as will be obvious to one skilled in the art, could be located on any of the memory devices.

The mass storage device 910 is a non-limiting example of a non-transitory computer-readable storage medium bearing computer-readable code for implementing the stereoscopic presentation creation methodology described herein. The non-transitory computer readable (storage) medium may be a computer readable signal medium or a computer readable storage medium. Other examples of a computer readable storage medium include, but are not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a RAM, a ROM, an erasable programmable ROM (EPROM or Flash memory), an optical fiber, a portable compact disc ROM (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

The processing system may have an operating system (OS) stored on one or more of the memory devices. The OS may include any of the conventional computer operating systems, such as those available from Microsoft of Redmond Wash., commercially available as Windows® OS, such as, for example, Windows® XP, Windows® 7, Windows® 8 and Windows® 10, MAC OS from Apple of Cupertino, Calif., or Linux.

The ROM 908 may include boot code for the processing system, and the CPU 902 may be configured for executing the boot code to load the OS to the RAM 906, executing the operating system to copy computer-readable code to the RAM 906 and execute the code.

A network connection 920 provides communications to and from the processing system over a network, such as for example, the network 200. For example, the data packets which include the angular position and temporal information (in some embodiments) or the actuation commands (in other embodiments) may be transmitted to the network 200 for receipt by the content controller 170. Typically, a single network connection provides one or more links, including virtual connections, to other devices on local and/or remote networks. Alternatively, the processing system can include more than one network connection (not shown), each network connection providing one or more links to other devices and/or networks.

All of the components of the processing system are connected to each other (electronically and/or data), either directly or indirectly, through one or more connections, exemplified in FIG. 9 as a communication bus 914.

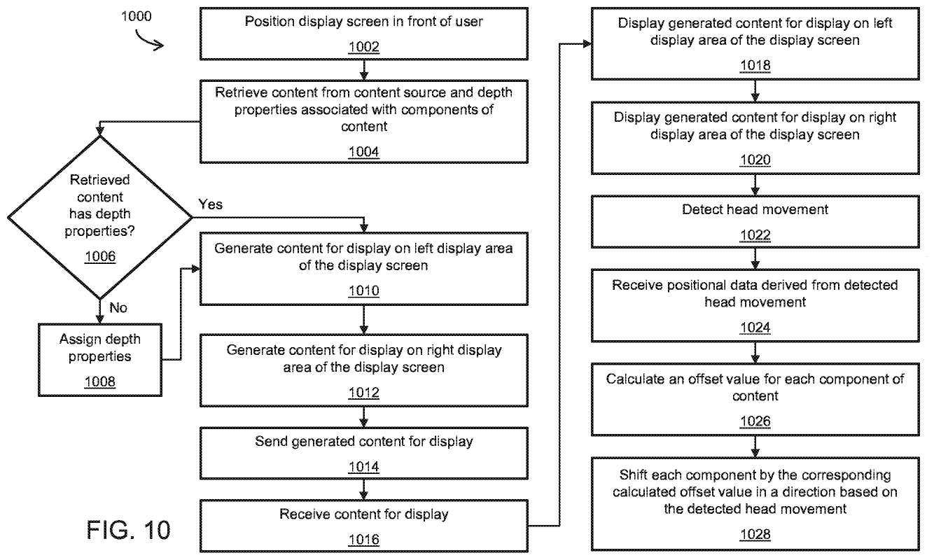

Attention is now directed to FIG. 10 which shows a flow diagram detailing a computer-implemented process 1000 in accordance with embodiments of the disclosed subject matter. The computer-implemented process includes steps for displaying stereoscopic content retrieved from a content source on a head-mounted display. Reference is also made to the elements shown in FIGS. 1-9. The process and sub-processes of FIG. 10 are computerized processes performed by the system 100 and related components, such as the content rendering module 120 and the processing units 114 and 132.

The process 1000 begins at block 1002 where the display 142 is positioned in front of the user, by placing the HMD 140 on the head 182, to align the left display area 142a with the left eye 186a, and to align right display area 142b with the right eye 186b. The process 1000 then moves to block 1004, where the content rendering module 120 retrieves content, that includes one or more two-dimensional components, from the content source 150. The user 180 may actuate the content rendering module 120, via user input to the system 100, to retrieve the content. In practice, the actuation for retrieval of content may be effectuated by the user 180 browsing, via the web browser 160, to a website, which triggers the content rendering module 120 to perform the content retrieving actions.

The process then moves to block 1006, where the content rendering module checks the retrieved content to determine whether the components of the retrieved content have assigned depth values. The checking in block 1006 may be performed by reading data file information associated with the retrieved content and/or analyzing computer code from the content source 150 that dictates how the content is to be displayed. For example, in instances when the content source 150 is a website, the checking in block 1006 may include analyzing HTML code of the website. If the content rendering module 120 determines that the components lack associated depth properties (i.e., depth properties not included in the data file information), the process 1000 moves from block 1006 to block 1008, where the content rendering module 120 assigns depth properties to each component. The process 1000 then moves to blocks 1010 and 1012. If the content rendering module 120 determines that the components have associated depth properties (i.e., depth properties included in the data file information), the process 1000 moves from block 1006 to blocks 1010 and 1012.

In blocks 1010 and 1012 the content rendering module 120 reconstructs the content from the content source 150 twice, to generate a left-eye version of the content for display on the left display area 142a and a separate right-eye version of the content for display on the right display area 142b. The generation of the left-eye version of the content (in block 1010) and the right-eye version of the content (in block 1012) is performed by applying, for each component, a separate left-shift and right-shift, by a pixel offset associated with the depth properties of the component. As a result, each component in the left-eye version of the content has a corresponding oppositely shifted component in the right-eye version of the content.

The process 1000 then moves to block 1014, where the content rendering module 120 sends the generated content for display on corresponding areas of the display 142. Specifically, the left-eye version of the content is sent for display on the left display area 142a, and the right-eye version of the content is sent for display on the right display area 142b. The routing and processing of the content for display may be performed by the processing unit 132. The process 1000 then moves to block 1016, where the display 142 receives the corresponding content for display, for example via a data bus. The process 1000 then moves to blocks 1018 and 1020, where the left display area 142a displays the left-eye version of the content, and the right display area 142b displays the right-eye version of the content, respectively.

The process 1000 then moves to block 1022, where the sensor subsystem 110, and more particularly the sensors 112 (e.g., accelerometers), collects measurement data to detect movement of the head 182 of the user 180. The processing unit 114 receives the collected measurement data and determines the head position (in free space and/or angular position). The sensor subsystem 110 then provides the head position, derived from the collected measurement data, in the form of data, to the content rendering module 120.

The process 1000 then moves to block 1024, where the content rendering module 120 receives the head positional data from the sensor subsystem 110. The process 1000 then moves to block 1026, where the content rendering module 120 calculates a pixel offset value for each component. The calculated pixel offset value is a function of the perceived depth of the component (i.e., a function of the depth properties of the component) and is also a function of the head position (in free space and/or angular position) provided to the content rendering module 120 by the sensor subsystem 110 in response to detected movement of the head 182. The process 1000 then moves to block 1028, where the content rendering module 120 shifts each component by its corresponding calculated pixel offset value. The shift, as executed in block 1028, is performed in a direction opposite to that of the direction of movement detected by the sensor subsystem 110 in block 1022. For example, movement to the left results in a shift of each component to the right by its corresponding calculated pixel offset value, and movement to the right results in a shift of each component to the left by its corresponding calculated pixel offset value.

Although not illustrated explicitly in FIG. 10, subsequent to applying the pixel shift to the components, the content rendering module 120 sends the left-eye version of the content for display on the left display area 142a and sends the right-eye version of the content for display on the right display area 142b, similar to as performed in block 1014.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system, such as the OS of the processing system illustrated in FIG. 9.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the drawings illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A system for displaying content, comprising:
a head-mounted display including a display configured to be positioned in front of a user, the display having a first display area for displaying content for a right eye of the user and a second display area for displaying content for a left eye of the user; and
a content rendering module configured to:
retrieve, from a content source, content that includes one or more two-dimensional components of content, each of the one or more components having associated depth properties, the depth properties of each component having an associated offset value,
generate content for the first display area from the retrieved content by applying, for each of the one or more components, a horizontal shift to the component in a respective first direction by the offset value associated with the component,
generate content for the second display area from the retrieved content by applying, for each of the one or more components, a horizontal shift to the component in a respective second direction opposite the respective first direction by the offset value associated with the component, and
send the generated content to the respective first and second display areas.

2. The system of claim 1, wherein the content is web content.

3. The system of claim 1, wherein content source is a website.

4. The system of claim 1, wherein the depth properties of each of the one or more components are assigned by the content rendering module.

5. The system of claim 1, wherein the depth properties of each of the one or more components are assigned by the content source.

6. The system of claim 1, wherein the head-mounted display is configured to:
receive the generated content for the first display area and the generated content for the second display area,
display on the first display area the generated content for the first display area, and
display on the second display area the generated content for the second display area.

7. The system of claim 1, wherein the first and second display areas are non-overlapping display areas.

8. The system of claim 1, further comprising:
a sensor subsystem functionally associated with the head-mounted display, the sensor subsystem configured to:
detect movement of the head of the user, and
based on the detected movement, provide positional data associated with the head of the user to the content rendering module.

9. The system of claim 8, wherein the content rendering module is further configured to:
receive the positional data from the sensor subsystem, and
for each of the one or more components, apply a horizontal shift by a second offset value in the first direction or the second direction, wherein the direction of the horizontal shift by the second offset value is a function of the received positional data.

10. The system of claim 9, wherein the second offset value is a function of the depth properties of the component.

11. The system of claim 9, wherein the received positional data is indicative of rotational or translational movement of the head of the user in the first or second directions.

12. The system of claim 11, wherein the horizontal shift by the second offset value is in a direction opposite the direction of rotational or translational movement of the head of the user.

13. The system of claim 8, wherein the sensor subsystem includes at least one sensor in the form of an accelerometer.

14. The system of claim 8, wherein the sensor subsystem is carried by the head-mounted display.

15. A method for displaying content, comprising:
positioning a display of a head-mounted display in front of a user, the display having a first display area for displaying content for a right eye of the user and a second display area for displaying content for a left eye of the user;
retrieving, from a content source, content that includes one or more two-dimensional components of content, each of the one or more components having associated depth properties, the depth properties of each component having an associated offset value;
applying, for each of the one or more components, a horizontal shift to the component in a respective first direction by the offset value associated with the component to generate content for the first display area from the retrieved content;
applying, for each of the one or more components, a horizontal shift to the component in a respective second direction opposite the respective first direction by the offset value associated with the component to generate content for the second display area from the retrieved content; and
sending the generated content to the respective first and second display areas.

16. The method of claim 15, further comprising:
receiving the generated content for the first display area and the generated content for the second display area;
displaying on the first display area the generated content for the first display area; and
displaying on the second display area the generated content for the second display area.

17. The method of claim 15, further comprising:
detecting movement of the head of the user;
receiving positional data associated with the head of the user, the positional data being derived from the detected head movement; and
for each of the one or more components, applying a horizontal shift by a second offset value in the first or second direction according to the received positional data.

18. A system for displaying content, comprising:
a head-mounted display configured to be positioned in front of a user, the head-mounted display including a display having a first display area and a second display area;
a sensor subsystem functionally associated with the head-mounted display configured to:
detect movement of the head of the user, and
derive positional data associated with the head of the user from the detected movement; and
a content rendering module configured to:
retrieve, from a content source, content that includes one or more two-dimensional components of content, each of the one or more components having associated depth properties,
receive the positional data from the sensor subsystem,
calculate, for each of the one or more components, an associated offset value based on the depth properties of the component and the derived positional data,
generate content for the first display area from the retrieved content by applying, for each of the one or more components, a horizontal shift to the component in a respective first direction by the offset value associated with the component,
generate content for the second display area from the retrieved content by applying, for each of the one or more components, a horizontal shift to the component in a respective second direction opposite the respective first direction by the offset value associated with the component.

19. A method for displaying content, comprising:
displaying, on a first display area of a head-mounted display positioned in front of a user, a first version of one or more two-dimensional components of content derived from source content;
displaying, on a second display area of the head-mounted display, a second version of the one or more two-dimensional components of content derived from source content, wherein for each of the one or more components, the component of the first version is horizontally shifted in a first direction by an offset amount associated with a depth property of the component, and a corresponding component of the second version is horizontally shifted in a second direction opposing the first direction by the offset amount;
receiving positional data indicative of movement of the head of the user;
calculating, for each of the one or more components, a second offset value based on the depth properties associated with the components and the received positional data; and
applying, for each of the one or more components of the first and second versions, a horizontal shift to the component in the first direction or the second direction by the second offset value associated with the component.
